(19) United States
(12) Patent Application Publication
(10) Pub. No.: US 2019/0342860 A1
(43) Pub. Date: Nov. 7, 2019

(54) MESSAGES BROADCASTING EXPLOITING DEVICE-TO-DEVICE TRANSMISSION

(71) Applicant: TELECOM ITALIA S.p.A., Milano (IT)

(72) Inventors: Marco CARETTI, Torino (IT); Giovanni NARDINI, Pisa (IT); Dario SABELLA, Torino (IT); Giovanni STEA, Pisa (IT); Antinio VIRDIS, Pisa (IT)

(73) Assignee: TELECOM ITALIA S.p.A., Milano (IT)

(21) Appl. No.: 16/477,386

(22) PCT Filed: Jan. 9, 2018
(86) PCT No.: PCT/EP2018/050427

§ 371 Date: Jul. 11, 2019

(30) Foreign Application Priority Data
Jan. 16, 2017 (IT) 102017000003921

(51) Int. Cl. H04W 72/00; H04W 8/00; H04W 16/14; H04W 72/04; H04W 4/06

(52) U.S. Cl. CPC H04W 72/005; H04W 8/005; H04W 88/04; H04W 72/048; H04W 4/06; H04W 16/14

(57) ABSTRACT

A method of broadcasting a message among user equipment in a broadcast area covered by a wireless communication network is proposed. The wireless communication network comprises at least one radio base station which is adapted to manage communications of user equipment in one or more respective served areas. The method comprises having the at least one radio base station identifying user equipment comprised in the broadcast area; among the user equipment within the broadcast area, estimating a set of transmitter user storing the message to be broadcasted; among the user equipment within the broadcast area, estimating a set of receiver user equipment not storing the message and being able to receive the message sent by at least one transmitter user equipment through a device to device communication, and selecting a subset of transmitter user equipment for transmitting the message ensuring that the receiver user equipment in said set receive the message with a predetermined confidence.

### BACKGROUND OF THE INVENTION

### Field of the Invention

The solution according to embodiments of the present invention refers to telecommunications. In detail, the solution according to embodiments of the present invention relates to the broadcast of messages among user terminals, or User Equipment—UE—(e.g., a smartphone, a tablet, a laptop, etc.) connected to a telecommunication network. In more detail, the solution according to embodiments of the present invention relates to a method and a system for broadcasting messages exploiting device-to-device, or D2D, transmission.

### Overview of the Related Art

Wireless communication networks offer the possibility to broadcast messages when the need arises. For example, it is desirable to broadcast emergency messages (e.g., in case of vehicular collision, natural disasters, etc.) or Distributed Hash Table, or DHT, lookup requests (e.g., in order to ‘discover’ Internet of Things, or IoT; devices deployed in the proximity and information/functionalities offered by such IoT devices), which are likely to be originated by UE. In addition, broadcast messages may comprise proximity-based advertisement messages, which are likely to be made available at a radio base station, or RBS (e.g., evolved node B, or eNB, in the Long Term Evolution, LTE, and Long Term Evolution—Advance, LTE-A, radio communication technologies), that manages communications over a served area, or cell, comprising UE that are wished to be reached by the proximity-based advertisement.

These messages must be propagated in a well-defined target area, or broadcast area, which not necessarily corresponds to a single cell of the wireless telecommunication network (e.g., the target area may comprise either a portion of a cell or may encompass more than one cell, or portions of cells).

Moreover, the broadcast of a message must be reliable and the broadcast area must be covered preferably in a short time, either because of a well-defined deadline, or because the performance of high-level applications that send these broadcast messages depends on how fast the broadcast messages propagate in the broadcast area.

The broadcast of messages should consume as few network resources as possible in order not to hamper the normal operation (e.g., UE to UE communications) of the wireless communication network.

In LTE and LTE-Advanced (LTE-A) wireless communication networks, D2D transmission may be exploited for implementing broadcast as proposed in G. Nardini, G. Stea, A. Virdis, D. Sabella, M. Caretti: “Broadcasting in LTE-Advanced networks using multihop D2D communications”, PIMRC 2016, Valencia, Sep. 5-7, 2016. The paper discloses that in an LTE-Advanced network, network-controlled Device-to- Device (D2D) communications can be combined in a multihop fashion to distribute broadcasts over user-defined (and possibly large) areas, with small latencies and occupying few resources.

### SUMMARY OF THE INVENTION

The Applicant has observed that, generally, the expedients known in the art do not provide a reliable and controlled broadcast of messages and, at the same time, with a minimum impact on the operation of the communication network.

For example, the approach described in the paper mentioned above relies either on allocating static resources that UE can exploit for SideLink, or SL, transmissions or having the radio base station schedule SL transmissions upon the reception of a Random ACcess, or RAC, requests from UE that need to relay the message to be broadcasted.

Such expedient provokes a large number of collisions (either on the SL or on the RAC), which jeopardize a reliability of the broadcast and of forecast of a time instant at which the broadcast is completed. Moreover, a definition of geographical bounds of the target area of the broadcast is inaccurate.

The Applicant has therefore tackled the problem of how to solve, or at least mitigate, the drawbacks mentioned above.

Accordingly, the Applicant reached for a solution in which a radio base station (such as a eNB) guides the diffusion of message broadcast by means of D2D transmissions, minimizing collisions and the associated exploitation of resources available to the radio base station for providing communication in the respective cell, and also speeding up a propagation of the broadcasted message among UE in the target area.

Particularly, one aspect of the present invention proposes a method of broadcasting a message among user equipment in a broadcast area covered by a wireless communication network. The wireless communication network comprises at least one radio base station which is adapted to manage communications of user equipment in one or more respective served areas. The method comprises having the at least one radio base station identify user equipment comprised in the broadcast area; among the user equipment within the broadcast area, estimating a set of transmitter user storing the message to be broadcasted; among the user equipment within the broadcast area, estimating a set of receiver user equipment not storing the message and being able to receive the message sent by at least one transmitter user equipment through a device to device communication, and selecting a subset of transmitter user equipment for transmitting the message ensuring that the receiver user equipment in said set receive the message with a predetermined confidence.

Preferred features of the present invention are set in the dependent claims.

In an embodiment of the present invention, selecting a subset of transmitter user equipment for transmitting the message comprises selecting a minimum number of transmitter user equipment of said set ensuring that the receiver user equipment receive the message with a predetermined confidence.

In an embodiment of the present invention, estimating a set of transmitter user equipment comprised in the broadcast area, estimating a set of receiver user equipment comprised in the broadcast area, and selecting a subset of transmitter user equipment for transmitting the message are based on a probabilistic criterion.

In an embodiment of the present invention, estimating a set of transmitter user equipment comprised in the broadcast area comprises estimating a user equipment within the broadcast area being a transmitter user equipment if a probability that said user equipment stores the message equals or exceeds a predetermined threshold.

In an embodiment of the present invention, estimating a set of receiver user equipment comprised in the broadcast area comprises estimating a user equipment within the broadcast area being a receiver user equipment if a probability that said user equipment receives the message through a device to device transmission equals or exceeds a further predetermined threshold.

In an embodiment of the present invention, the predetermined threshold corresponds to the further predetermined threshold.

In an embodiment of the present invention, selecting a subset of transmitter user equipment for transmitting the message comprises solving a set cover problem.

In an embodiment of the present invention, the set cover problem is formulated as follows:

$$min {\sum }_{i ∈ TS} {x}_{i} , \\ such that$$

$$1 - {\prod }_{i ∈ TS} ( 1 - {P}_{i} \cdot {P}_{i , j} \cdot {x}_{i} ) \geq {α}_{TH} ∀ j ∈ RS$$

$${x}_{i} ∈ \{ 0 , 1 \} ∀ i ∈ TS ,$$

where xᵢ is a binary variable that is set to one if a corresponding transmitter user equipment is selected for the subset of transmitter user equipment for transmitting the message, and is set to zero otherwise, Pᵢ is the probability that the transmitter user equipment stores the message, P_{i,j} is a probability that a transmission from the transmitter user equipment is correctly received and decoded by a receiver user equipment, RS is a set comprising the receiver user equipment, TS is a set comprising the transmitter user equipment, and α_{TH} is the predetermined threshold.

In an embodiment of the present invention, the set cover problem is formulated as follows:

$$min {\sum }_{i ∈ TS} {x}_{i} , \\ such that$$

$${\sum }_{i ∈ TS} {x}_{i} log ( 1 - {P}_{i} \cdot {P}_{i , j} ) \leq log ( 1 - {α}_{TH} ) ∀ j ∈ RS$$

$${x}_{i} ∈ \{ 0 , 1 \} ∀ i ∈ TS ,$$

where xᵢ is a binary variable that is set to one if a corresponding transmitter user equipment is selected for the subset of transmitter user equipment for transmitting the message, and is set to zero otherwise, Pᵢ is the probability that the transmitter user equipment stores the message, P_{i,j} is a probability that a transmission from the transmitter user equipment is correctly received and decoded by a receiver user equipment, RS is a set comprising the receiver user equipment, TS is a set comprising the transmitter user equipment, and α_{TH} is the predetermined threshold.

In an embodiment of the present invention, the predetermined threshold is a configurable threshold whose value is associated with a reliability of the broadcast.

In an embodiment of the present invention, the predetermined threshold is equal to, or greater than, 0.8.

In an embodiment of the present invention, the predetermined threshold is equal to 0.9 or 0.95.

In an embodiment of the present invention, the method further comprises allocating network resources for the transmission of the message to selected transmitter user equipment. Preferably, said allocating network resources comprises allocating a portion of network resources, available for communications from user equipment towards the radio base station, to selected transmitter user equipment for performing a device-to-device communication.

In an embodiment of the present invention, allocating network resources further comprises exploiting frequency reuse in order to allocating a same network resource to two or more selected transmitter user equipment.

In an embodiment of the present invention, allocating network resources further comprises assessing whether a reduction in the probability of receiving the message through a device to device transmission occurs for any receiver user equipment due to interference provoked by exploiting frequency reuse for two or more selected transmitter user equipment. Moreover, allocating network resources further comprises cancelling the frequency reuse whether the probability drops below the further predetermined threshold for any receiver user equipment.

An embodiment of the present invention further comprises assessing anew the probability of storing the message for each user equipment comprised in the broadcast area after network resources have been allocated to the selected transmitter user equipment.

In an embodiment of the present invention, the method further comprises reiterating the following steps: estimating a set of transmitter user equipment comprised in the broadcast area; estimating a set of receiver user equipment comprised in the broadcast area; selecting a subset of transmitter user equipment for transmitting the message, and assessing anew a probability of storing the message for each user equipment comprised in the broadcast area.

In an embodiment of the present invention, estimating a set of transmitter user equipment comprised in the broadcast area; estimating a set of receiver user equipment comprised in the broadcast area; selecting a subset of transmitter user equipment for transmitting the message, and assessing anew a probability of storing the message for each user equipment comprised in the broadcast area are reiterated while for at least one user equipment comprised in the broadcast area the newly assessed probability of storing the message is lower than the predetermined threshold.

In an embodiment of the present invention, assessing anew a probability of storing the message for each user equipment comprised in the broadcast area comprises estimating that the probability that a user equipment comprised in the broadcast area store the message is equal to the corresponding probability that said user equipment receives the message through a device to device transmission previously assessed.

In an embodiment of the present invention, the method further comprises receiving the message from a core network of the wireless communication network.

In an embodiment of the present invention, the method further comprises allocating network resources to at least one selected transmitter user equipment for transmitting the message to the radio base station.

In an embodiment of the present invention, the method further comprises identifying the broadcast area based on information contained in the message.

In an embodiment of the present invention, the method further comprises providing the message to at least one further radio base station through an interface arranged for communication between radio base stations, the served area of the further radio base station being at least partially superimposed to the broadcast area.

In an embodiment of the present invention, the method further comprises having the radio base station or the at least one further radio base station providing the message to at least one user equipment located within the broadcast area.

In an embodiment of the present invention, providing the message to at least one user equipment comprises providing the message to at least one user equipment having the minimum maximum shortest path with respect to other user equipment within the broadcast area.

In an embodiment of the present invention, the method further comprises receiving a Random Access Channel request from a user equipment in the served area for transmitting the message through a device to device transmission.

In an embodiment of the present invention, further comprising receiving a Buffer Status Report requesting a grant of network resources sufficient to transmit the message.

Another aspect of the solution according to the present invention refers to a wireless communication network comprising at least one radio base station which is adapted to manage communications of user equipment in one or more respective served areas, the least one radio base station being configured for implementing the method of above.

### BRIEF DESCRIPTION OF THE DRAWINGS

These and others features and advantages of the solution according to embodiments of the present invention will be better understood by reading the following detailed description of an embodiment thereof, provided merely by way of non-limitative example, to be read in conjunction with the attached drawings, wherein:

FIG. 1A-1C are schematic representations of a portion of a wireless communication network in which a D2D-based messages broadcast according to an embodiment of the present invention is implemented;

FIG. 2 is a schematic flowchart of a broadcast procedure for managing the D2D-based message broadcast according to an embodiment of the invention;

FIG. 3 is a schematic diagram illustrating frequency reuse during network resources scheduling according to an embodiment of the invention;

FIG. 4A is a schematic diagram a portion of a wireless communication network in which a D2D-based messages broadcast according to an embodiment of the present invention is implemented over two cells of the wireless communication network;

FIG. 4B is a schematic diagram a portion of a wireless communication network in which a D2D-based messages broadcast according to an alternative embodiment of the present invention is implemented over two cells of the wireless communication network;

FIG. 5 is a schematic diagram a portion of a wireless communication network in which a D2D-based messages broadcast according to an embodiment of the present invention is implemented over five cells of the wireless communication network, and

FIGS. 6A-6C are plots of figures of merit of the D2D-based messages broadcast according to an embodiment of the present invention and known expedients based on a simulation of a test scenario.

### DETAILED DESCRIPTION OF THE INVENTION

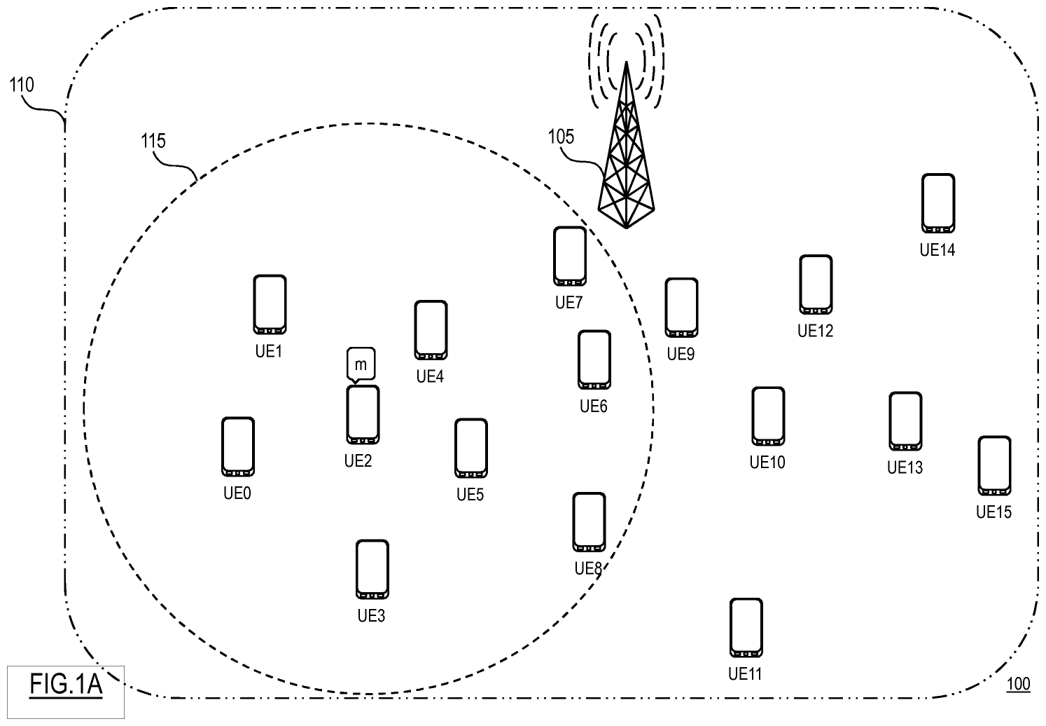

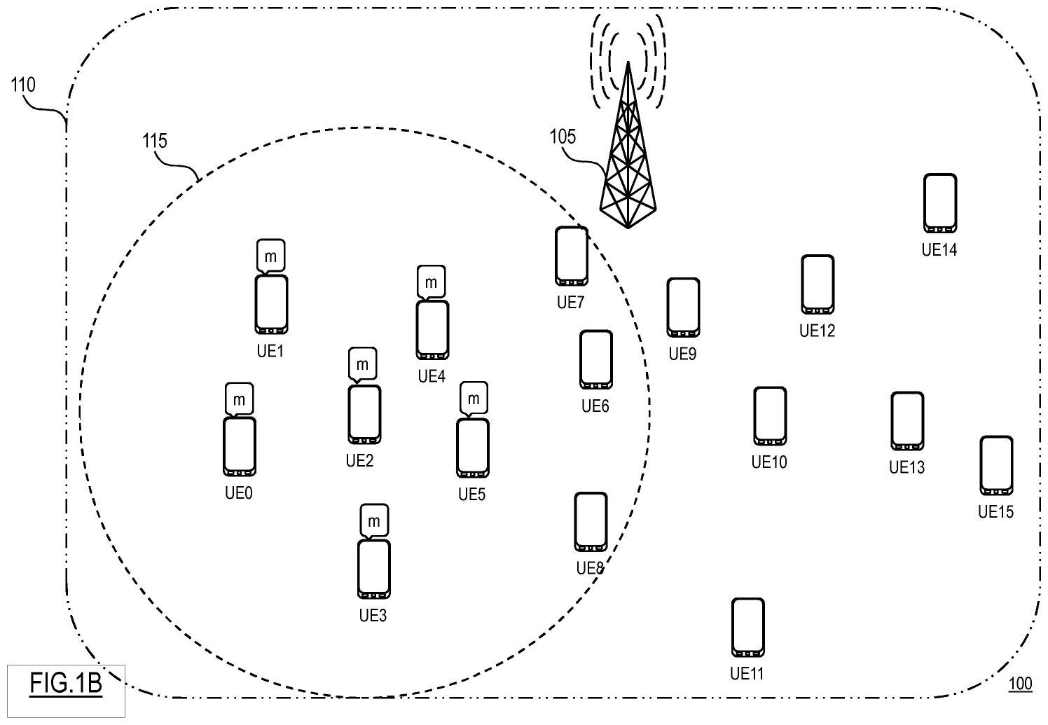

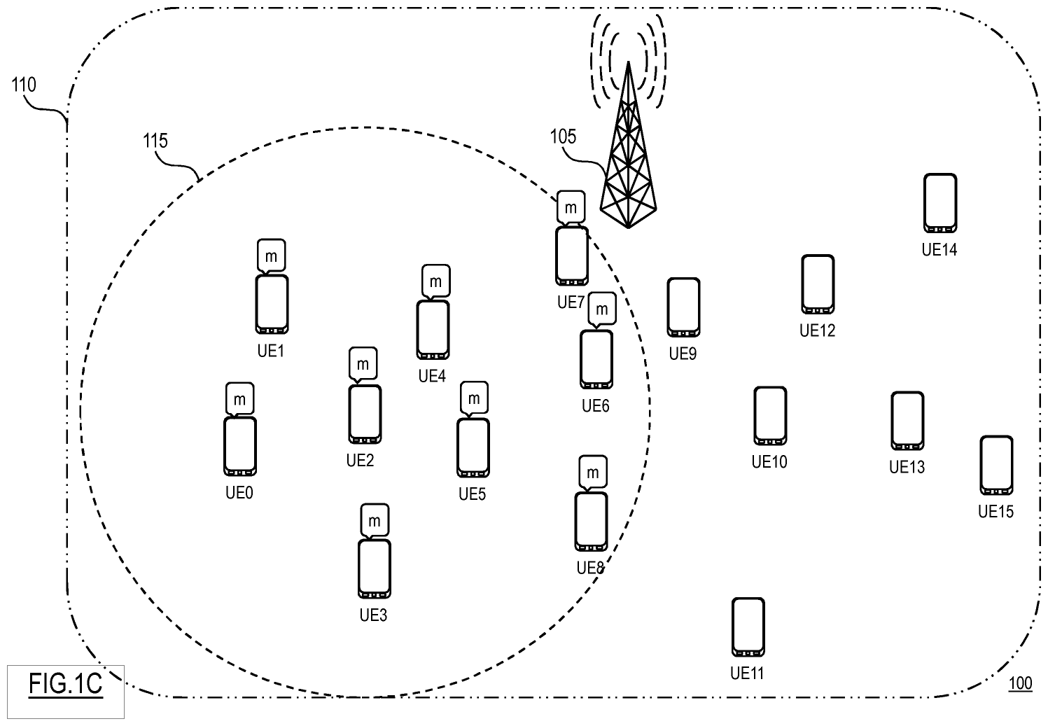

With reference to the drawings, FIGS. 1A-1C are schematic representations of a portion of a wireless communication network 100 in which a device-to-device based, or D2D-based, messages broadcast according to an embodiment of the present invention is implemented.

The portion of the wireless communication network 100 comprises a radio base station, or RBS, 105 (e.g., evolved node B, or eNB, in the Long Term Evolution, LTE, and Long Term Evolution—Advance. LTE-A radio communication technologies), which manages communications over a respective served geographic area, or cell 110.

In detail, the radio base station 105 is arranged for providing communication services (transmission and reception of voice calls, data packets, etc.) to user equipment, such as the user equipment UE₀₋₁₅ (e.g., smartphones, tablets, laptops, etc.), comprised in the cell 110.

According to an embodiment of the invention, the radio base station 105 is configured for managing a D2D-based messages broadcast according to embodiments of the present invention.

In the following it is assumed that the radio base station 105 has the capability of estimating a position of each user equipment UE₀₋₁₅ comprised in the cell 110 served by the radio base station 105. For example, the radio base station may implement one or more of any UE positioning functions known in the art in order to estimate a geographic position of each one of the user equipment UE₁₅ within the cell 110.

In a non-limiting embodiment of the invention, the wireless communication network 100 implements LTE/LTE-A technology configured for managing device-to-device communications (e.g., LTE release 12 and LTE-A release 12) among user equipment capable of performing direct communications one with the other.

In the example illustrated in FIGS. 1A-1C, it is considered the case in which, initially, a message m to be broadcasted—denoted by a balloon containing a m in the FIGS. 1A-1C—is generated by a user equipment, such as the user equipment UE₂ in FIG. 1A, for example for warning people in the surrounding that a car accident has occurred.

In order to initiate the broadcast of the message m, the user equipment UE₂ requests to the radio base station 105 network resources needed to perform the broadcast.

The user equipment UE₂ sends a Random Access, or RAC, request to the radio base station 105.

Preferably, the user equipment UE₂ further sends a Buffer Status Report, or BSR, to the radio base station 105 in order to ask for a grant of network resources sufficient to transmit the message m.

Particularly, the network resources are requested for implementing one or more D2D transmissions of the message m to be broadcasted. In other words, the user equipment UE₂ requests a grant for a sidelink, SL, for transmitting the message to be broadcasted directly to one or more of the user equipment UE₀₋₁₅ comprised within the cell 110.

The radio base station 105, by analyzing the BSR received from the user equipment UE₂, may recognize that the user equipment UE₂ is requesting a grant for a sidelink SL in order to initiate a D2D-based messages broadcast. For example, an indication that the user equipment UE₂ is willing to initiate the D2D-based messages broadcast may be contained in a specific value of the Logical Connection ID, or LCID, field of the BSR (i.e., the BSR does not necessarily requires changes in order to implement the D2D-based messages broadcast according to embodiments of the present invention).

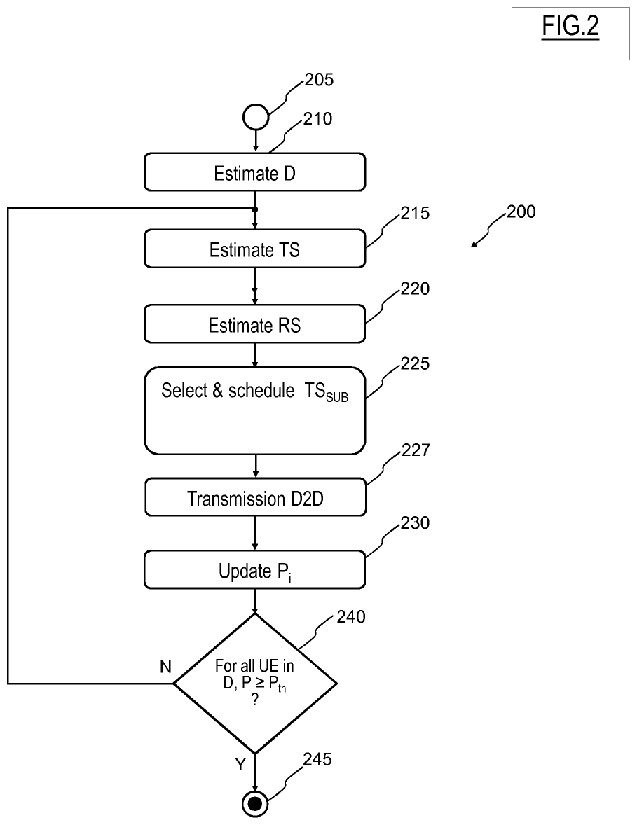

Once the radio base station 105 identifies that the user equipment UE₂ is requesting resources for D2D-based messages broadcasting, the radio base station 105 may instantiate a D2D-based broadcast managing procedure, broadcast procedure 200 for short in the following, according to an embodiment of the present invention, which is now described by further making reference to FIG. 2, which is a schematic flowchart thereof.

As noted above, the broadcast procedure 200 is initiated (start block 205) at a radio base station, such as the radio base station 105 in the example of FIGS. 1A-1C, by identifying a request for grant of a sidelink SL made by a user equipment, such as the user equipment UE₂, in order to initiate a D2D-based messages broadcasting.

Firstly, the radio base station determines (block 210) a set D of the user equipment UE₀₋₈ comprised in the cell 110 that are also comprised within a broadcast area 115 (delimited by a dashed circle in FIGS. 1A-1C) of the broadcast.

The broadcast area 115 is an area within which the message m is to be broadcasted. In other words, the message m has to be received by each user equipment, such as the user equipment UE₀, UE₁ and UE₃₋₈ in the example at issue, comprised within the broadcast area 115.

In an embodiment of the invention, the broadcast area 115 may be substantially discoidal and a broadcast radius r_{b} may be associated with the message m to be broadcasted. In this case, the broadcast radius r_{b} is used for determining an extent of the broadcast area 115.

Preferably, the broadcast area 115 is centered on the source of the broadcasted message m, i.e. the user equipment UE₂ in the example at issue.

Even more preferably, a length of the broadcast radius r_{b} and/or an extent of the broadcast area 115, may be a predefined parameter or may be defined by the user equipment UE₂ that generate the message m (as described in the following).

Nonetheless, nothing prevents from defining the broadcast area 115 according to different criteria and/or having different shapes without departing from the scope of the invention.

In the example of FIGS. 1A-1C, the user equipment UE₀₋₈ are comprised in the broadcast area 115 and therefore in the UE set D identified by the radio base station 105, i.e.: D={U₀, UE₁, UE₂, UE₃, UE₄, UE₅, UE₆, UE₇, UE₈}.

Then, the radio base station 105 identifies (block 215) a (possible) transmitters' set TS of user equipment UE₀₋₈ that currently (i.e., during the considered iteration of the broadcast procedure 200) store the message m to be broadcasted.

It should be noted that, in a first iteration of the broadcast procedure 200, only the user equipment that has generated the message m, such as the user equipment UE₂ in the example of FIGS. 1A-1C, stores the message m to be broadcasted (i.e., at the first iteration TS={UE₂}) with a storing probability Pᵢ, i.e. a probability that the UEᵢ (where i=0, . . . , 8, in the example of FIGS. 1A-1C) stores the message m, equal to unity (i.e., Pᵢ=1).

In successive iterations of the broadcast procedure 200, the radio base station 105 identifies the user equipment UE₀₋₈ belonging to the transmitters set TS (i.e., currently storing the message m) based on a probabilistic criterion. For example, a generic user equipment UEᵢ is inserted in the transmitters set TS whether the storing probability Pᵢ equals or exceeds a reliability threshold α_{TH} (i.e., Pᵢ≥α_{TH}; as described in the following).

Preferably, the reliability threshold α_{TH} is a configurable threshold whose value is associated with a reliability of the broadcast, for example typical values may be set equal to, or greater than, 0.8 (i.e., α_{TH}≥0.8) such as preferably α_{TH}=0.9 or α_{TH}=0.95.

After defining the set TS, the radio base station 105 defines a (possible) receivers' set RS (block 220) comprising receiver user equipment UEⱼ (where j=0, . . . , 8, and j # 2 in the example of FIGS. 1A-1C) comprised in the broadcast area 115 that are likely to receive the broadcast message m transmitted by the user equipment UEᵢ of the transmitters set TS based on the aforementioned probabilistic criterion. Preferably, a (message) reception probability Pⱼ, i.e. a probability that the UEⱼ receives the message m by means of a D2D transmission thereof, is computed (as described in the following). Accordingly, the generic user equipment UEⱼ is inserted in the receivers set RS in case the reception probability Pⱼ equals or exceeds the reliability threshold α_{TH} (i.e., Pⱼ≥α_{TH}; as described in the following).

Accordingly, the radio base station 105 selects and schedules (block 225) a broadcast subset TS_{SUB} of of user equipment UEᵢ comprised in the transmitters set TS, to which transmission grants are provided by the radio base station 105 in order to propagate the message m (as described in the following).

Preferably, during each iteration of the broadcast procedure 200, the broadcast subset TS_{SUB} is selected and scheduled in such a way to minimize an overall number of transmissions of the message m during the D2D-based broadcast thereof, and, at the same time, to ensure that the message m is received by the user equipment UEⱼ comprised in the receivers set RS with the reception probability Pⱼ equaling or exceeding the reliability threshold α_{TH} (i.e., Pⱼ≥α_{TH}; as described in the following).

Advantageously, the user equipment UEᵢ comprised in the broadcast subsets TS_{SUB} are also selected in such a way to minimize network resources to be allocated for performing the D2D-based messages broadcast (as described in the following). For example, in an embodiment of the invention, frequency reuse may be implemented in order to reduce an amount of network (transmission) resources allocated for broadcasting the message m (as described in the following).

Once the user equipment UEᵢ in the broadcast subset TS_{SUB} have transmitted (block 227) the message m, the storing probability Pᵢ that each user equipment UE₀₋₈ in the broadcast area 115 store the message m is newly assessed (block 230).

For example, user equipment EUⱼ of the receivers set RS that, probabilistically, are likely to have just received the message m are regarded as now storing the message m with a storing probability Pᵢ equal to the receipt probability Pⱼ (i.e., Pᵢ=Pⱼ≥α_{TH}).

Then, the radio base station 105 assesses (decision block 240) for all the user equipment UE₀₋₈ in the broadcast area 115, i.e. the user equipment UE₀₋₈ comprised in the UE set D, whether the corresponding storing probability Pᵢ is equal to or greater than the reliability threshold α_{TH}. In other words, the radio base station 105 estimates whether all the user equipment UE₀₋₈ comprised in the UE set D store (i.e. have received) the message m.

In the affirmative case (exit branch Y of decision block 240), i.e. the broadcast of the message m has reached all the user equipment UE₀₋₈ comprised in the broadcast area 115, the broadcast procedure 200 ends (block 245).

In the negative case (exit branch N of decision block 240), i.e. the broadcast of the message m has not reached all the user equipment UE₀₋₈ comprised in the broadcast area 115, operation returns at block 215, in order to start a new iteration of the broadcast procedure 200—i.e., the new iteration entails repeating the operations of blocks 215, 220, 225, 227, 230, 240.

According to an embodiment of the present invention, the broadcast procedure 200 is iterated until the broadcast of the message m has reached all the user equipment UE₀₋₈ comprised in the broadcast area 115.

It should be noted that each (D2D) transmission of the message m requires four (4) Transmission Time Intervals (TTIs, known in the art and not herein discussed for the sake of brevity) to be decoded by the user equipment UEⱼ in the receivers set RS. Accordingly, each iteration of the broadcast procedure 200 follows a previous iteration after four TTIs and precedes a next iteration by four TTIs.

With reference to the example of FIGS. 1A and 1B the broadcast procedure 200 manages the D2D-based broadcast in the broadcast area 115 of the message m in the following manner.

The radio base station 105, upon receiving a grant request for network resources on a sidelink SL from the user equipment UE₂ for performing a D2D-based message broadcast, populates the UE set D with the user equipment UE₀₋₈ comprised in the broadcast area 115, as noted above.

As it should be clear, in the example at issue only the user equipment UE₂ (which generates the message m) initially stores the message m to be broadcasted with a storing probability P₂ equal to one (P₂=1). Accordingly, only the user equipment UE₂ is inserted in the transmitters set TS by the radio base station 105 (i.e., TS={UE₂}).

The radio base station 105 then identifies the user equipment UE₀, UE₁, UE₃, UE₄ and UE₅ as able to receive the message m with a reception probability Pⱼ equaling or exceeding the reliability threshold α_{TH}; thus, the user equipment UE₀, UE₁, UE₃, UE₄ and UE₅ are comprised in the receivers set RS (i.e., RS={U₀, UE₁, UE₃, UE₄, UE₅}).

Since the transmitters set TS only comprises the user equipment UE₂, in such a first iteration of the broadcast procedure 200 only the user equipment UE₂ is inserted in the broadcast subsets TS_{SUB} (i.e., TS_{SIB}={UE₂}).

The user equipment UE₂ receives a grant of transmission on the sidelink SL by the radio base station 105, and performs a D2D transmission of the message m.

The user equipment UE₀, UE₁, UE₃, UE₄ and UE₅ in the receivers set RS are considered having received the message m (each with a respective confidence corresponding the respective reception probability Pⱼ) as shown in FIG. 1B. Therefore, each user equipment UE₀, UE₁, UE₃, UE₄ and UE₅ is (from now) considered to store the message m with a respective storing probability Pᵢ substantially equal to the reception probability Pⱼ (i.e., Pᵢ=Pⱼ≥α_{TH}).

Since the user equipment UE₆, UE₇ and UE₈ in the broadcast area 115 have not received the message m yet, the broadcast procedure 200 is reiterated (i.e., the operations of blocks 215, 220, 225, 227, 230, 240 are repeated).

In the new iteration, the radio base station 105 inserts in the transmitters set TS all the user equipment EUᵢ that are deemed to store the message m with a storing probability Pᵢ equaling or exceeding the reliability threshold α_{TH}. In the example at issue, the user equipment UE₀, UE₁, UE₃, UE₄ and UE₅ (which received the message m in the previous iteration of the broadcast procedure 200) and the user equipment UE₂ (which generated the message m) comply with such constrain (i.e., Pᵢ≥α_{TH}), and are accordingly comprised in the transmitters set TS (i.e., RS={UE₀, UE₁, UE₂, UE₃, UE₄, UE₅}).

Afterwards, a new receivers set RS is identified. In the example of FIGS. 1B and 1C, all the three remaining user equipment UE₆, UE₇ and UE₈ not already storing the message m result being able to receive the message m with a reception probability Pⱼ equaling or exceeding the reliability threshold α_{TH} (i.e., Pⱼ≥α_{TH}) and are thus comprised in the receivers set RS (i.e., RS={UE₆, UE₇, UE₈}).

The radio base station 105 selects (as described in the following) which user equipment UEᵢ to schedule for transmitting the message m by means of D2D transmission and grants them network resources (e.g., one or more resource blocks) in the SL. In the example of FIGS. 1B and 1C, the radio base station 105 determines that is possible to provide the message m to the user equipment UE₆, UE₇ and UE₈ in the receivers set RS (with the desired confidence, i.e. Pⱼ≥α_{TH}) by granting transmission only to the user equipment UE₄ and UE₅ in the transmitters set TS. Accordingly, the user equipment UE₄ and UE₅ are inserted in the broadcast subset TS_{SUB} (i.e., TS_{SUB}={UE₄, UE₅}).

The user equipment UE₄ and UE₅ receive a grant of transmission on the sidelink SL by the radio base station 105, and perform a D2D transmission of the message m.

The user equipment UE₆, UE₇ and UE₈ in the receivers set RS are considered having received the message m (each with a respective confidence corresponding to the respective reception probability Pⱼ) as shown in FIG. 1C. Therefore, each user equipment UE₆, UE₇ and UE₈ is (from now on) considered to store the message m with a respective storing probability Pᵢ equal to the receipt probability Pⱼ (i.e., Pᵢ=Pⱼ≥α_{TH}).

As FIG. 1C shows, all the user equipment UE₀₋₈ in the broadcast area 115 (i.e., the user equipment UE₀₋₈ comprised in the UE set D) are now considered to store the message m. In other words, all the user equipment UE₀₋₈ in the broadcast area 115 have received the message m and the broadcast is completed (i.e., the broadcast procedure 200 terminates).

According to an embodiment of the present invention, the selection and scheduling of user equipment UEᵢ for D2D transmission (i.e., the selection user equipment UEᵢ to be comprised in the broadcast subset TS_{SUB}; see block 225 of the broadcast procedure 200) may be performed as follows.

Preferably, a selection and scheduling sub-broadcast procedure may be implemented. Even more preferably, the selection and scheduling sub-broadcast procedure comprises two (2) phases, namely a (first) selection phase and a (second) scheduling phase.

The selection phase of the selection and scheduling sub-broadcast procedure is configured to select a (minimum) broadcast subset TS_{SUB} of user equipment UEᵢ comprised in the transmitter set TS whose D2D transmissions of the message m (probably) reaches all the user equipment UEⱼ in the receivers set RS

Thanks to the knowledge of the position of all user equipment UE₀₋₁₅ in the cell 110, the radio base station 105 may estimate the signal attenuation due to path loss between couples of (transmitter) user equipment UEᵢ and (receiver) user equipment UEⱼ in the broadcast area.

Based on the estimate of signal attenuation between couples of user equipment UEᵢ and UEⱼ and by exploiting BLock Error Rate, or BLER, curves used for selecting a Modulation and Coding Scheme, or MCS, for transmissions, the radio base station 105 computes for each pair of user equipment UEᵢ and UEⱼ comprised in the broadcast area 115 a reception (successful receipt of message) probability P_{i,j}, i.e. a probability that a transmission (e.g., the transmission of the message m to be broadcasted) from the transmitter user equipment UEᵢ is correctly received and decoded by the receiver user equipment UEⱼ.

The reception probability Pⱼ for a generic user equipment UEⱼ in the receivers set RS may be computed as the joint probability of receiving the message from a user equipment UEᵢ storing the message m, or

Pⱼ=1−Π_{i∈TS}(1−Pᵢ·P_{i,j}·xᵢ), (1)

where xᵢ is a binary variable that is set to one (1) if user equipment UEᵢ is selected for transmission (i.e., is comprised in the broadcast subset TS_{SUB}), and is set to zero (0) otherwise.

The above equation (1) expresses a probabilistic variant of a set cover problem, also indicated simply as ‘problem’ in the following, with constraints on an amount of available resources.

Solving the set cover problem is NP-hard (Non-deterministic Polynomial-time hard, i.e. a class of problems complexity known in the art and not herein further discussed for the sake of brevity) and requires a huge number of variables for its completion. For example, in a scenario comprising 40 user equipment having available 50 resource blocks on the sidelink SL for D2D transmissions, a number of binary variables required for solving the set cover problem substantially corresponds to 40×50=2000 (i.e., 2000 binary variables for indicating which user equipment is transmitting in which corresponding resource block), and further 40×40×50=80000 binary variables are required for indicating whether two (or more) generic user equipment are exploiting a same resource block for transmission.

Based on equation (1) it is possible to identify a (minimum) broadcast subset TS_{SUB} of user equipment UEᵢ in the transmitter set TS whose D2D transmissions of the message m (probably) reaches all the user equipment UEⱼ in the receivers set RS.

In fact, given the transmitters set TS of user equipment UEᵢ that (probably) store the message m it is to be identified the broadcast subset TS_{SUB} of user equipment UEᵢ in the transmitter set TS whose D2D transmissions of the message m (probably) allows reaching all the user equipment UEⱼ in the receivers set RS and allocating network resources to such user equipment UEᵢ in the broadcast subset TS_{SUB} for transmitting the message m (operation performed at block 225 in the flowchart of FIG. 2). The allocation of network resources preferably comprises optimizing the usage thereof, for example by implementing frequency reuse (hence, posing interference constraints to the solution) and exploiting a limited number of network resources (e.g., resource blocks).

The selection phase of the selection and scheduling sub-broadcast procedure entails solving the probabilistic set cover problem, assuming infinite network resources and without implementing frequency reuse. Under such assumptions, the solution to the set cover problem is accelerated and simplified.

Particularly, the set cover problem may be formulated as follows:

minΣ_{i∈TS}xᵢ, (2)

such that

1−Π_{i∈TS}(1−Pᵢ·P_{i,j}·xᵢ)≥α_{tH}∀j∈RS (3)

xᵢ∈{0,1}∀i∈TS (4)

The problem may be linearized by reformulating inequality (3):

minΣ_{i∈TS}xᵢ,

such that

Σ_{i∈TS}xᵢlog(1−Pᵢ·P_{i,j})≤log(1−α_{TH})∀j∈RS xᵢ∈{0,1}∀i∈TS. (5)

The solution of the set cover problem identifies the user equipment UEᵢ to be comprised in the broadcast subset TS_{SUB}.

It should be noted that the user equipment UEᵢ identified by solving the set cover problem according to inequality (3) and/or inequality (5) ensure that the reception probability Pⱼ for each user equipment UEⱼ of the receiver set RS equals or exceeds the reliability threshold am as required.

It should be noted that, since all the user equipment UEᵢ of the broadcast subset TS_{SUB} transmit the same message m with the same modulation coding scheme, the same amount of network resources (e.g., one resource block) is allocated to each user equipment UEᵢ of the broadcast subset TS_{SUB}.

Due to the assumption made above (i.e., infinite network resources and no frequency reuse), it is likely that the required network resources to be allocated for the transmission of the message m by the user equipment UEᵢ comprised in the broadcast subset TS_{SUB} exceed the currently available network resources (i.e., network resources in the uplink, UL, which may be exploited for establishing a sidelink; SL, for D2D communication as known).

An example of selection and scheduling sub-broadcast procedure according to an embodiment of the present invention is herein provided in the form of the following pseudo-code, in which it is assumed that each user equipment UEᵢ of the broadcast subset TS_{SUB} is scheduled in one resource block, RB, without loss of generality. Moreover, in the pseudocode:
U is the set of schedulable user equipment UEᵢ (i.e., the broadcast subset TS_{SUB});
rbAlloc is a matrix, or map, that stores, for each resource block RBₖ (wherein k is a positive integer), the user equipment UEᵢ allocated on it.
ueAlloc is a vector that stores, for each user equipment UEᵢ, the RBₖ allocated to it.

It should be noted that, in the following pseudo-code according to an embodiment of the invention, a simplified scheduling phase is implemented. The simplified scheduling phase is configured to discard the scheduling of user equipment UEᵢ of the broadcast subset TS_{SUB} for which resource blocks are not effectively available. In other words, in case the number of UEᵢ is greater than a number K (K>0) of effectively available resource blocks RBk, the user equipment UEᵢ allocated in any RBₖ, with k>K (e.g., k=K+1) are not scheduled by the radio base station 105. In other words, the algorithm described by the pseudo-code does not comprise optimization of network resources exploitation, even though implementing a frequency reuse criteria. Indeed, the algorithm described by the pseudo-code allocates user equipment UEᵢ in a generic RBₖ by means of one or more trials, e.g. according to a ‘greedy’ criterion, without ensuring that the final allocation is an optimal solution with respect to one or more selected constraint and/or metrics.

| | |
|---|---|
| 1 | // initialization |
| 2 | sort UEs in U according to a given policy |
| 3 | for each k in B { |
| 4 | add UE k to rbAlloc [k] |
| 5 | ueAlloc[k] = k |
| 6 | } |
| 7 | |
| 8 | // allocation |
| 9 | for each UE i in U { |
| 10 | tempRbAlloc = rbAlloc |
| 11 | prev = ueAlloc[i] |
| 12 | remove i from tempRbAlloc[prev] |
| 13 | for each k in tempRbAlloc { |
| 14 | add i to tempRbAlloc [k] // try to allocate UE i on RB k |
| 15 | for each UE j in U { // evaluate probabilities |
| 16 | compute P_j according to tempRbAlloc |
| 17 | } |
| 18 | if P_j > alpha, for each UE j { // update allocation |
| 19 | remove i from rbAlloc [prey] |
| 20 | add i to rbAlloc [k] |
| 21 | go to the next UE |
| 22 | } |
| 23 | else { |
| 24 | remove i from tempRbAlloc[k] |
| 25 | } |
| 26 | } |
| 27 | } |

The selection and scheduling sub-broadcast procedure according to preferred embodiments of the present invention comprises a scheduling phase in which one or more optimization techniques, such as for example frequency reuse, are implemented, in order to reduce network resources, e.g. resource blocks, required for the D2D-based broadcast of the message m and allowing scheduling a number of UEᵢ of the broadcast subset TS_{SUB} greater than network resources, e.g. a number of resource blocks, effectively available.

Preferably, the radio base station 105 allocates network resources for the transmission of the message m by the user equipment UEᵢ of the broadcast subset TS_{SUB} using a heuristic scheduling algorithm.

Preferably, in a first portion of the heuristic scheduling algorithm, the available network resources are firstly assigned to the user equipment UEᵢ of the broadcast subset TS_{SUB} in a mutual exclusive manner (i.e., respective network resources are allocated to each user equipment UEᵢ of the broadcast subset TS_{SUB}).

Afterwards, in a second portion of the heuristic scheduling algorithm, frequency reuse is implemented by allocating corresponding network resources to two or more user equipment UEᵢ of the broadcast subset TS_{SUB}. In other words, the transmission of the message m by two or more user equipment UEᵢ of the broadcast subset TS_{SUB} may be scheduled on the same network resources.

Preferably, upon applying frequency reuse the radio base station 105 checks whether the message probability P_{i,j} and, accordingly, the reception probability Pⱼ change due to interference associated with the frequency reuse. Even more preferably, the radio base station 105 checks whether the reception probability Pⱼ remains equal to, or greater than, the reliability threshold α_{TH}(Pⱼ≥α_{TH}). In the affirmative case (i.e. the reception probability Pⱼ remains equal to, or greater than, the reliability threshold α_{TH}), the frequency reuse is enforced. Otherwise (i.e. the reception probability Pⱼ becomes lower than the reliability threshold α_{TH}), the frequency reuse is discarded.

In the exemplary D2D-based broadcast scenario of FIGS. 1A-1C according to a non-limiting embodiment of the invention, the selection and scheduling sub-broadcast procedure may be implemented in the following manner. As described above, user equipment UE₂ is the only user equipment UEᵢ in the transmitters set TS, while user equipment UE₀, UE₁, UE₃, UE₄ and UE₅ are in (D2D communication) reach from UE₂ and are included in the receivers set RS.

A possible solution of the probabilistic set cover problem is a Candidate Active Set, or CAS, i.e. corresponding to the broadcast subset TS_{SUB}, containing only user equipment UE₂, which is scheduled for transmission by the heuristic scheduling algorithm in available network resources, such as four (4) resource blocks RB₀₋₃ out of six (6) resource blocks RB₀₋₅ totally available for transmission on the sidelink.

After the transmission of the message m, user equipment UE₀, UE₁, UE₃, UE₄ and UE₅ in the receivers set RS have the message m with the desired confidence (Pᵢ≥α_{TH}).

During the second iteration of the broadcast procedure 200, the radio base station 105 instantiates the selection and scheduling sub-procedure (second iteration of block 225) in the transmitters set TS that now comprises user equipment UE₀₋₅.

The solution to the set cover problem is performed in the first phase of the selection and scheduling sub-procedure and results in the selection of user equipment UE₄ and UE₅ for covering (i.e., providing the message m to) the user equipment UE₆, UE₇ and UE₈ comprised in the receivers set RS in such a second iteration of the broadcast procedure 200 (i.e., user equipment UE₄ and UE₅ are comprised in the broadcast subset TS_{SUB}).

Subsequently the second phase of the selection and scheduling sub-procedure is instantiated for scheduling D2D transmission of user equipment UE₄ and UE₅.

In the first portion of the heuristic scheduling algorithm, user equipment UE₄ and UE₅ are scheduled on four resource blocks each, for a total of eight (8) resource blocks allocated, which exceeds the six (6) totally available resource blocks RB₀₋₆ totally available for transmission on the sidelink.

Accordingly, in the second portion of the heuristic scheduling algorithm, frequency reuse is implemented, for example the user equipment UE₄ and UE₅ may be scheduled for transmission in the same four (4) resource blocks RB₀₋₃, provided that the reception probability Pⱼ for the user equipment UE₆, UE₇ and UE₈ comprised in the receivers set RS is not critically affected by interference associated with the frequency reuse scheme determined by the heuristic scheduling algorithm (i.e., Pⱼ does not drop below the reliability threshold α_{TH}).

After the transmission of the message m in the second iteration, all the user equipment UE₆, UE₇ and UE₈ comprised in the receivers set RS have the message with the desired confidence (Pᵢ≥α_{TH}). Moreover, all the user equipment UE₀₋₈ in the broadcast area 115 have received the message m, and the broadcast procedure 200 terminates.

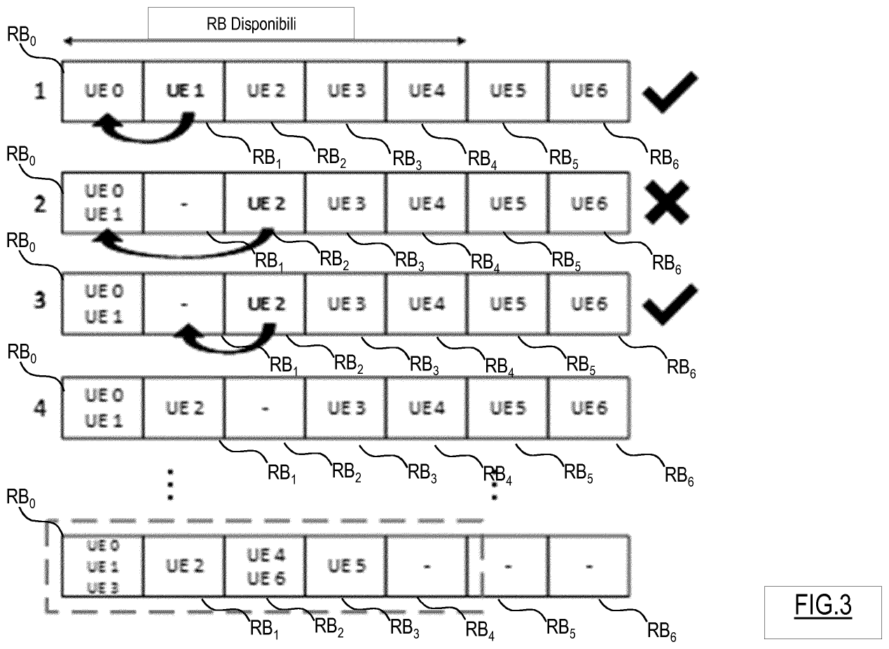

A more general example of frequency reuse according to an embodiment of the invention is shown in FIG. 3, which is a schematic diagram illustrating frequency reuse during network resources scheduling according to an embodiment of the invention.

In the example of FIG. 3, seven user equipment UE₀₋₆ are comprised in the broadcast subset TS_{SUB}. In the first portion of the heuristic scheduling algorithm, one or more respective network resources, e.g. one respective resource block in the example of FIG. 3, are allocated to each user equipment UE₀₋₆. This guarantees that interference constraints of the set cover problem are satisfied.

It should be noted that seven (7) resource blocks RB₀₋₆ are allocated (one for each user equipment UE₀₋₆ although only five (5) resource blocks RB₀₋₄ are effectively available in the example.

Accordingly, frequency reuse is implemented during the second portion of the heuristic scheduling algorithm. In a first iteration of the frequency reuse, user equipment UE₁ is tentatively scheduled for transmission in resource block RB₀, together with user equipment UE₀. In this case, transmissions from user equipment UE₀ and UE₁ in the same resource block RB₀ would generate interference (at least in transmissions and/or reception between user equipment UE₀ and UE₁), but the reception probability Pⱼ for all the user equipment in the receivers set RS is assessed (by a managing radio base station as described above) to remain above the reliability threshold α_{TH}. Thus, resource block RB₀ is also allocated to user equipment UE₁ for transmission (i.e., frequency reuse is enforced for user equipment UE₁).

At a second iteration of the frequency reuse, user equipment UE₂ is tentatively scheduled for transmission in resource block RB₀ as well. However, in this case, the cumulative interference would reduce the reception probability Pⱼ for at least one user equipment in the receivers set RS. Thus, user equipment UE₂ cannot be scheduled for transmission in resource block RB₀ (i.e., frequency reuse is not enforced for user equipment UE₂). Accordingly, at a third iteration of the frequency reuse, user equipment UE₂ is tentatively scheduled for transmission in resource block RB₁. Since no other user equipment is currently scheduled in resource block RB₁, user equipment UE₂ can be scheduled for transmission in resource block RB₁.

The iterations of the frequency reuse continue until all user equipment UE₀₋₆ in the broadcast subset TS_{SUB} have been parsed. In the example at issue at the end of the second phase of the selection and scheduling of user equipment UEᵢ, all user equipment UE₀₋₆ have been scheduled for transmission in the first four resource blocks RB₀₋₃, enforcing frequency reuse and maintaining the reception probability Pⱼ for all the user equipment in the receivers set RS remains above the reliability threshold α_{TH}.

The broadcast procedure 200 allows the radio base station 105 to control the broadcasting of the message m on the sidelink SL (i.e., a D2D-based broadcast) with the minimum amount of transmissions performed by the user equipment UE₀₋₈ in the broadcast area 115, which means reducing the network resources to be allocated for the broadcast and the interference generated within the cell 110 by the broadcast. Moreover, Random Access Channel, or RAC, handshake is required only initially (e.g., during the scheduling request performed by the user equipment UE₂ that generates the message m in the example of FIGS. 1A-1C), hence reducing occurrence of collisions and latency experienced by communications within the cell 110.

It should be noted that through the selection of the value of the reliability threshold α_{TH} it is possible to control erroneous scheduling of user equipment UE₀₋₈ that do not store the message m (e.g., assessed as a number of user equipment UE₀₋₈ erroneously scheduled for transmission) and broadcast delay (e.g., assessed as a time required to propagate the message m in the whole broadcast area 115). Indeed, higher values of the reliability threshold α_{TH} generally reduce the number of user equipment UE₀₋₈ erroneously scheduled for transmission, at the cost of additional broadcast transmissions and increasing broadcast delay (in order to have a high confidence that user equipment UE₀₋₈ scheduled for transmission store the message m). Lower values of the reliability threshold cow generally lead the radio base station 105 to identify the transmitters set TS comprising a large number of user equipment UE₀₋₈, at increased risk of scheduling for transmission user equipment UE₀₋₈ that not store the message m.

In an embodiment of the invention, it is possible to configure the user equipment UE₂ that originates the message m to define a specific broadcast area 115. For example, the user equipment UE₂ is configured for communicating an information, e.g. a parameter (e.g., the broadcast radius r_{b} mentioned above), allowing to the radio base station 105 to determine the broadcast area 115.

To this extent, the radio base station 105 may be configured to send also an uplink, UL, scheduling grant in response to a Buffer Status Report, BSR sent by the user equipment UE₂, e.g. on the TTI after sending the sidelink SL scheduling grant to the user equipment UE₂. Accordingly, the user equipment UE₂ may perform the first D2D-based broadcast transmission of the message m using the network resources allocated by the sidelink SL scheduling grant and, in addition, the user equipment UE₂ may send the message m also to the radio base station 105 using the network resources allocated by the uplink UL scheduling grant. The radio base station 105, in its turn, may configure the broadcast procedure 200 with the information regarding the specific broadcast area 115 contained in the message m; thus, allowing the radio base station 105 to correctly identify all the user equipment UE₀₋₈ comprised in the broadcast area 115 (to be included in the in the UE set D) among the user equipment UE₀₋₈ comprised in the cell 110 served by the radio base station 105.

It should be noted that the broadcast procedure 200 may be modified for managing the broadcast of a message m′ generated by a provider of wireless communication network 100 (both manually or automatically, e.g. by a computing arrangement comprised in the wireless communication network 100) or by a third party (e.g., advertisement companies, law enforcers, emergency operators, etc.). In this case, the message m′ is initially stored at the radio base station. For example, the message is provided to the radio base station through a core network (not shown) of the wireless communication network.

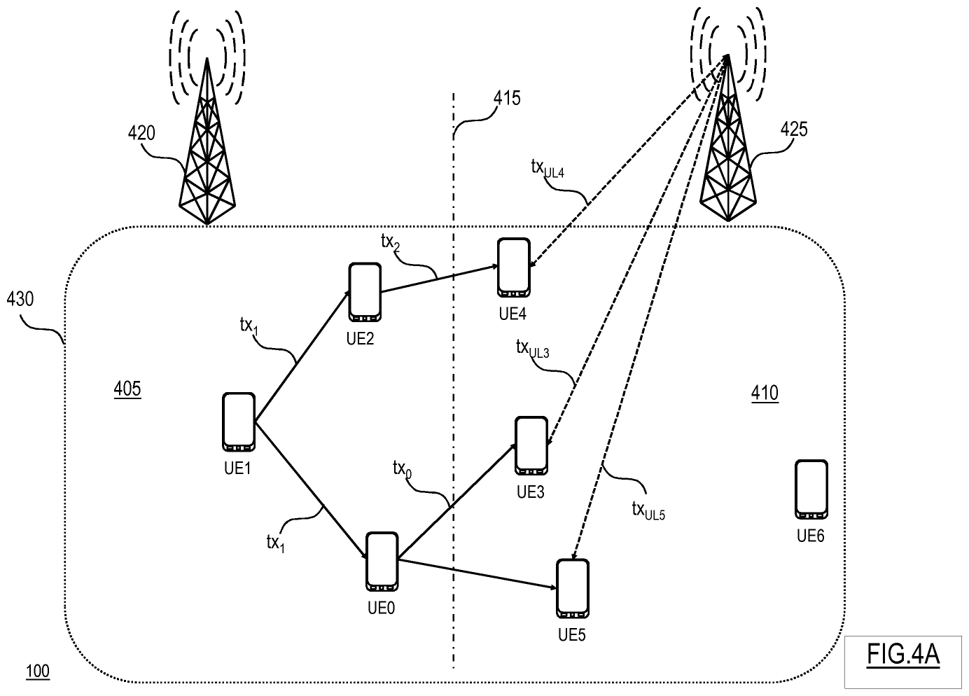

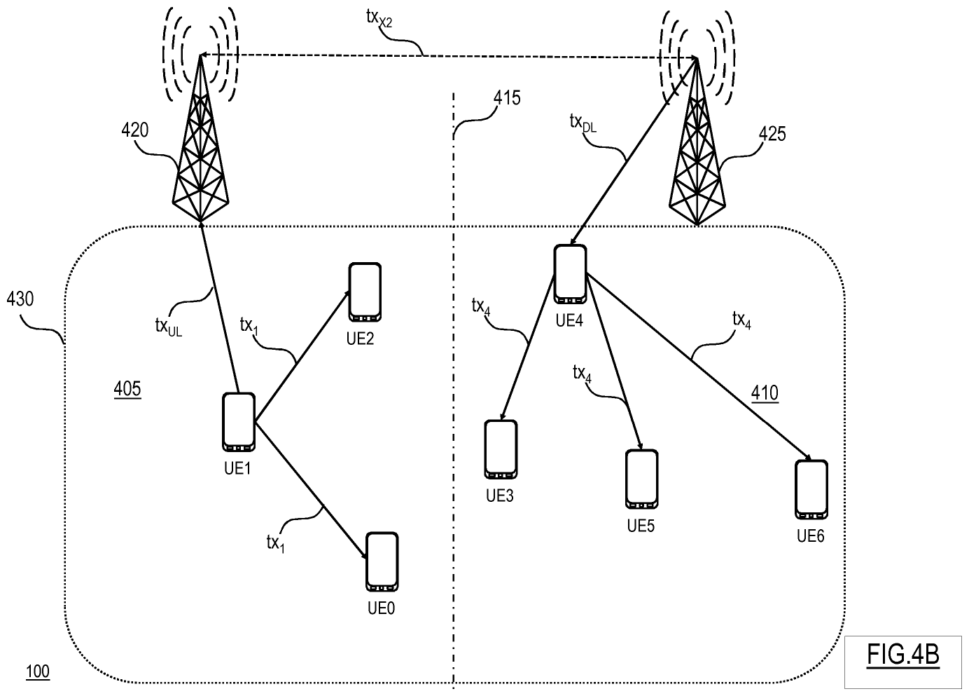

Therefore, the radio base station selects one or more user equipment within its cell and the broadcast area to which send the message m′ together with a scheduling grant on the sidelink SL for transmitting the message m′. Preferably, the radio base station 425, in FIG. 4A, may select which user equipment UE₃₋₆ provide with the message m according to a configurable policy.

Preferably, the radio base station may select as first receiver of the message m′ the user equipment having the minimum maximum shortest path with respect to other user equipment within the broadcast area. In other words, the first receiver of the message m′ is selected as the user equipment within the broadcast area (or portion of broadcast area superimposed to the cell served by the radio base station) which allows to provide the message m′ to the other user equipment minimizing a number of (D2D) transmissions to reach any other user equipment in the broadcast area (or portion of broadcast area superimposed to the cell served by the radio base station). Particularly, the selected first receiver of the message m′ is the user equipment which is able to provide the message m′ to a farthest user equipment (from the first receiver) among the user equipment in the broadcast area (or portion of broadcast area superimposed to the cell served by the radio base station) with a minimum number of D2D transmission.

Afterwards, the broadcast of the message m′ may proceed according to the broadcast procedure 200 described above.

The D2D-based messages broadcast according to embodiments of the present invention may perform the broadcast of a message to user equipment served by two or more different radio base station. For example, FIG. 4A is a schematic diagram a portion of the wireless communication network 100 in which a D2D-based messages broadcast according to an embodiment of the present invention is implemented over two cells 405 and 410 of the wireless communication network 100.

The cells 405 and 410 are neighboring cells along a boundary 415. Communications within the cells 405 and 410 are managed by corresponding radio base stations 420 and 425, respectively.

In the example of FIG. 4A, three user equipment UE₀₋₂ are comprised in the (first) cell 405 and, thus, are served by the (first) radio base station 420, while four further user equipment UE₃₋₆ are comprised in the (second) cell 410 and, thus, are served by the (second) radio base station 425.

All the user equipment UE₀₋₆ in the example of FIG. 4A are comprised in a broadcast area 430 defined for the propagation of the message m.

It is assumed that user equipment UE₁ generates the message m to be broadcasted and transmits (as indicated by arrows txi in FIG. 4A) on the sidelink SL according to the scheduling grant assigned by the radio base station 405 that implements a (first) instance of the broadcast procedure 200.

The message m is received by the user equipment UE₂ and UE₀ as described above. In their turn, the user equipment UE₂ and UE₀ transmit (indicated by arrows tx₀ and tx₂ in FIG. 4A) the message m on the sidelink SL according to the scheduling grant assigned by the radio base station 405. Such D2D-based broadcast of the message m can be received also by user equipment UE₃₋₅ served by the radio base station 425.

The one or more receiving user equipment UE₃₋₅ may transmit a RAC request to the radio base station 425 (as indicated by dashed arrows tx_{UL3}, tx_{UL4} and tx_{UL3} in FIG. 4A), i.e. the one or more receiving user equipment UE₃₋₅ operate as the user equipment that generates the message m in the cell 410. Accordingly, the radio base station 410 implements a (second) instance of the broadcast procedure 200 for broadcasting the message m in the respective cell 410.

Advantageously, the new instance of the broadcast procedure 200 implemented by the radio base station 425 is substantially independent from the instance of the broadcast procedure 200 implemented by its neighboring cell 420.

It should be noted that a propagation delay t_{d} is introduced each time a boundary between cells, such as the boundary 415, is crossed. Indeed, every time the message m is received by a user equipment, such as the user equipment UE₃₋₅ in a new cell, such as the cell 410, RAC and BSR handshake has to be completed by one or more of the user equipment UE₃₋₅ in the cell 410 before initiating a D2D-based broadcast of the message m. Such occurrence may slow down the propagation of the message m in the wireless communication network 100.

Advantageously, in an alternative embodiment of the invention, a X2 interface is exploited, arranged for communication between radio base stations, in order to eliminate, or at least reduce, the propagation delay _{T}_{_{d}} as shown in FIG. 4B, which is a schematic diagram a portion of the wireless communication network 100 in which a D2D-based messages broadcasting according to an alternative embodiment of the present invention is implemented over two cells 405 and 410 of the wireless communication network 100.

In this case, the broadcast procedure 200 is modified in the following manner. The radio base station 420 sends also an uplink scheduling grant in addition to the sidelink scheduling grant in response to the RAC and BSR sent by the user equipment UE₁. Accordingly, the user equipment UE₁ sends (as indicated by arrow txuL in FIG. 4B) the message m also to the radio base station 420 using the network resources allocated by the uplink scheduling grant in addition to D₂D transmitting the message m on the sidelink SL according to the scheduling grant assigned by the radio base station 420.

The radio base station 420 forwards the received message m to the neighboring cell 425 through the X2 interface (as indicated by dashed arrow tx_{X2} in FIG. 4B).

The radio base station 425 selects one or more of the user equipment UE₃₋₆, such as user equipment UE₄ in the example of FIG. 4B, within the respective cell 410. Preferably, the radio base station 425 may select which user equipment UE₃₋₆ provide with the message m according to a configurable policy. For example, the radio base station 425 may select the user equipment UE₄ having the minimum maximum shortest path (similarly as described above) with respect to other user equipment UE₃₋₆ within the broadcast area.

Therefore, the radio base station 425 sends the message m to the selected user equipment UE₄ (as indicated by arrow tx_{DL} in FIG. 4B). In addition, the radio base station 425 implements a respective instance of the broadcast procedure 200. This allows the radio base station 425 to implement an instance of the broadcast procedure 200 without the need for receiving a RAC request from one of the user equipment UE₃₋₆ within the respective cell 410.

Afterwards, the radio base station 425 schedules the user equipment UE₄, storing the message m, for the transmission on the sidelink in order to allow the user equipment UE₄ transmitting the message m to others user equipment UE_{3, 5-6} within the respective cell 410

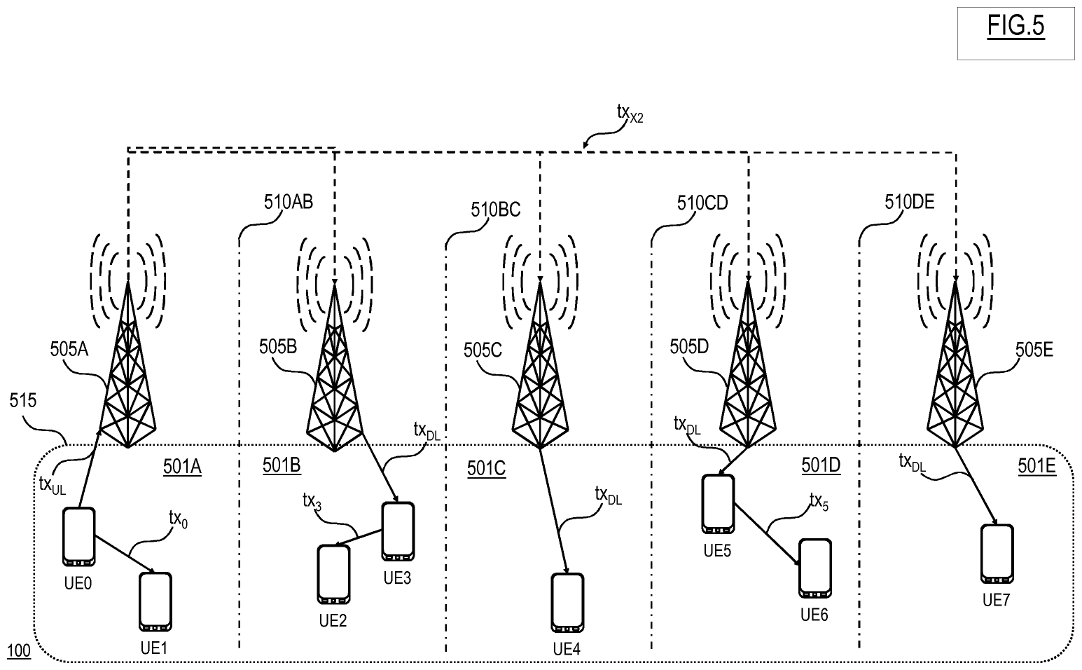

It should be noted that the radio base station that receives the message to be broadcasted through the uplink transmission may select to which radio base station it should send the message to be broadcasted based on the knowledge of the broadcast area (obtained from the message to be broadcasted as described above) as can be appreciated from FIG. 5, which is a schematic diagram a portion of the wireless communication network 100 in which a D2D-based messages broadcast according to an embodiment of the present invention is implemented over five cells 501A-E of the wireless communication network 100.

Communications within each one of the five cells 501A-E is managed by a respective radio base station 505A-E.

In the example at issue, each cell 501A-E is adjacent at least to another one of the cells 501A-E. A (first) boundary 510AB adjoins cell 501A from adjacent cell 501B, a (second) boundary 510BC adjoins cell 501B from adjacent cell 501C, a (third) boundary 510CD adjoins cell 501C from adjacent cell 501D, a (fourth) boundary 510DE adjoins cell 501D from adjacent cell 501E.

According to embodiments of the present invention, when a radio base station 505A-E, e.g. the radio base station 505A, receives a message m, provided on the uplink UL (as described above) by a served user equipment, e.g. user equipment UE₀, alongside implementing an instance of the broadcast procedure 200 for managing the D2D-based broadcast of the message m, the radio base station 505A operates as follows.

The radio base station 505A (storing the message m) may transmit—through the X2 interface X2—the message m substantially simultaneously to any other radio base station (i.e., the radio base stations 505B-E in the example of FIG. 5) of the wireless mobile network 100 whose respective cell is, at least partially, superimposed to the broadcast area 515.

Indeed, the radio base station 505A determines the extent of the broadcast area 515 associated with the message m from the information provided with, or within, the message m by the user equipment UE₀. Based on the knowledge of the broadcast area 515, the radio base station 505A is able to identify which radio base stations, i.e. the radio base stations 505B-E, serve the cells, i.e. the cells 505B-E, comprised in the broadcast area 515 should receive the message m and forward the latter to all of the radio base stations, i.e. the radio base station 505B-E, simultaneously.

Upon receiving the message m, each radio base station 505B-E implements a respective instance of the broadcast procedure 200 in order to manage the propagation of the message m within the respective cell 501B-E substantially independently from the other radio base stations 505B-E.

Thus, the propagation (i.e., the broadcast) of the message m may advance substantially at the same time in each one of the cells 501A-E of the wireless communication network 100 comprised in the broadcast area 515, sensibly reducing an overall time required for the broadcast of the message m.

This constitutes a desirable improvement in, for example, vehicular scenarios (i.e., real-time provision of traffic/accident messages) in which a message should be delivered along a road crossing a plurality of cells, e.g. the cells 501A-E, served by respective radio base stations, e.g. the radio base stations 505A-E. In fact, all the radio base stations, e.g. the radio base stations 505A-E, involved can start managing the D2D-based message broadcast substantially at the same time, drastically reducing the latency.

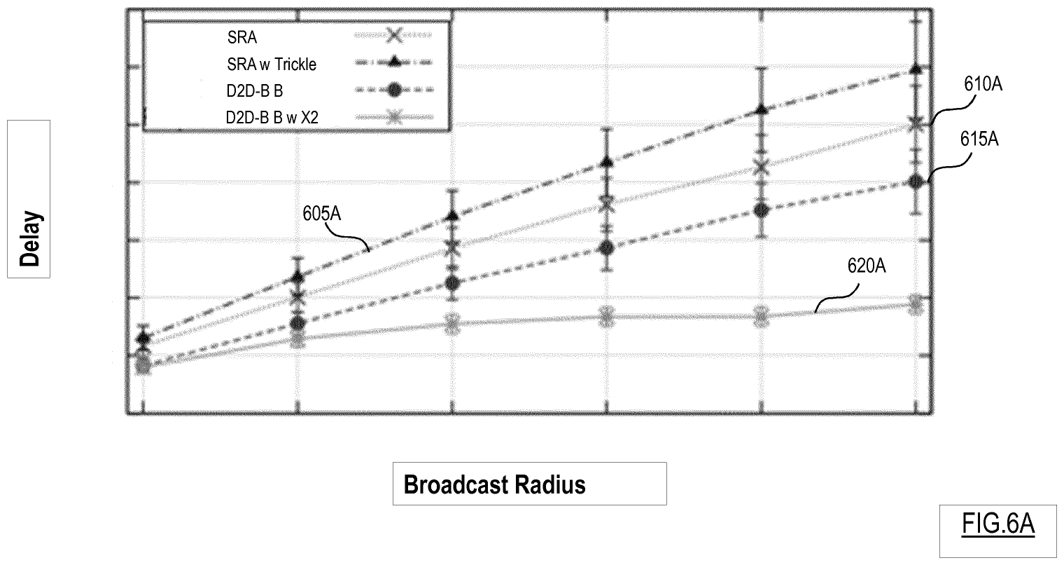

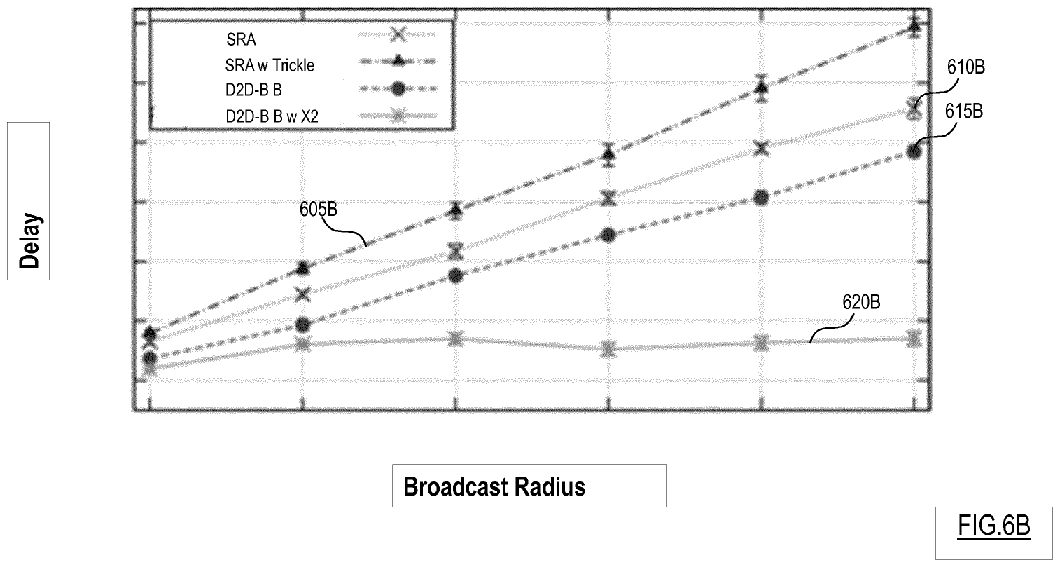

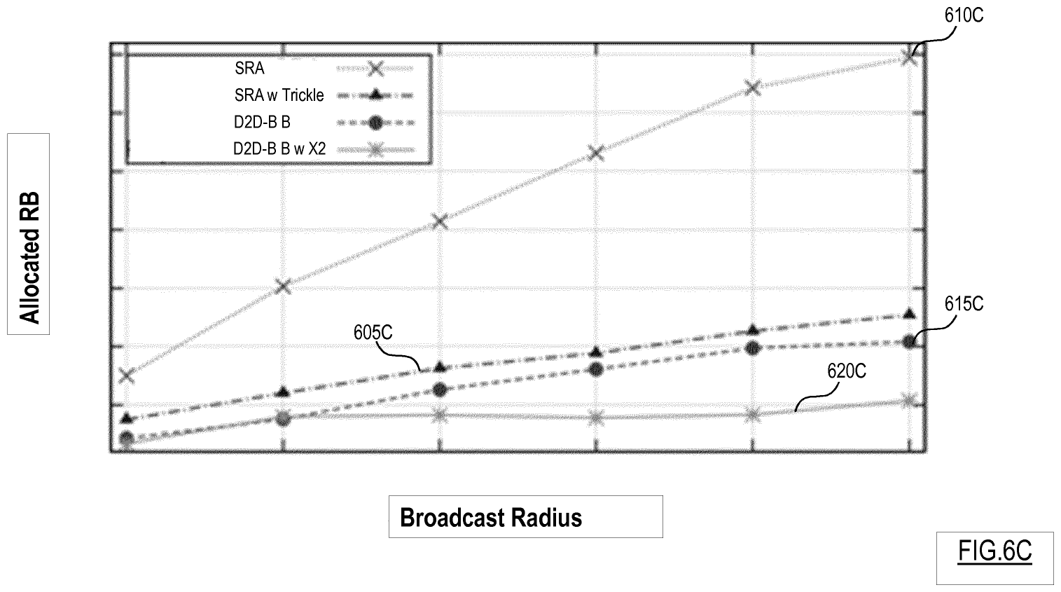

The D2D-based messages broadcast according to embodiment of the present invention has been evaluated in a test scenario described below and compared with known expedients as qualitatively shown in FIGS. 6A-6C, which are plots of figures of merit of the D2D-based messages broadcasting according to an embodiment of the present invention and known expedients based on a simulation of a test scenario.

The test scenario considers a portion of a wireless communication network comprising five radio base stations (e.g., the test scenario is substantially similar to the example of FIG. 5), where each radio base station is located at a distance d from other adjacent radio base station, in the non-limiting test scenario the distance d has been set equal to 400 m (i.e., d=400 m). Moreover, in the test scenario the user equipment are randomly located roughly along a straight line crossing cells served by the five radio base stations, as they represent user equipment carried by vehicles on a road.

The parameters of the test scenario are provided in the following Table 1.

TABLE 1
Test Scenario Parameters

| Bandwidth | 10 MHz (50 RBs) | |
|---|---|---|
| UE TX Power (UL) | 33 | dBm |
| UE TX Power (SL) | 15 | dBm |
| Sidelink CQI | 7 | |
| Number of UEs | 40 per cell (200 total) | |
| Test duration | 100 | s |

| | |
|---|---|
| Number of independent replicas | 3 |

wherein the number of independent replicas indicates the number of times that the test has been reiterated. Indeed, the overall results of the test have been obtained by averaging the results of each independent replica of the test performed.

The test scenario of data traffic, related to the D2D-based message broadcast, through the network 100 is generated as follows. For the test duration, one new event (i.e., a message) is generated on each second by a user equipment randomly selected among the user equipment comprised in the test scenario. Particularly, each selected user equipment triggers the implementation of an instance of the broadcast procedure 200 by sending a message to be broadcasted with a predetermined size of, e.g., 10 bytes to the respective serving radio base station at the application level.

The D2D-based messages broadcast according to embodiments of the present invention (both with and without exploiting the X2 interface for exchanging the message among radio base stations) is compared with the SRA mechanism (both with and without the Trickle algorithm) described in G. Nardini, G. Stea, A. Virdis, D. Sabella, M. Caretti: “Broadcasting in LTE-Advanced networks using multihop D2D communications”, PIMRC 2016, Valencia, Sep. 5-7, 2016.

The plot of FIG. 6A shows an average application-level delay (i.e., the time required for receiving the message computed from the start of the D2D-based message broadcast) experienced by the user equipment within the broadcast area. Particularly, the delay experienced by user equipment is expressed as a function of the broadcast radius r_{b} of the broadcast area considered.

A (first) curve 605A, dash-dotted line with triangles, describes the trend of the average application-level delay as a function of the broadcast radius r_{b} when the broadcast in the test scenario is implemented by instantiating the SRA exploiting the Trickle algorithm.

A (second) curve 610A, dotted line with crosses, describes the trend of the average application-level delay as a function of the broadcast radius r_{b} when the broadcast in the test scenario is implemented by instantiating the SRA (without exploiting the Trickle algorithm).

A (third) curve 615A, dashed line with dots, describes the trend of the average application-level delay as a function of the broadcast radius r_{b} when the broadcast in the test scenario is implemented by instantiating the D2D-based broadcast according to an embodiment of the present invention.

Finally, a (fourth) curve 620A, full line with asterisks, describes the trend of the average application-level delay as a function of the broadcast radius r_{b} when the broadcast in the test scenario is implemented by instantiating the D2D-based broadcast according to an embodiment of the present invention that exploits the X2 interface for forwarding the message among radio base stations.

FIG. 6A highlights that the SRA with Trickle algorithm (curve 605A) obtains the worst performance, because of the message suppression mechanism enforced by the Trickle algorithm in order to minimize a number of transmissions of the message. Both the considered embodiments of the D2D-based broadcast according to embodiments of the present invention (curves 615A and 620A) show better performance than SRA and SRA with Trickle algorithm (curves 605A and 610A). Particularly, the D2D-based broadcast exploiting X2 interface (curve 620A) provides substantially improved performance with respect to other solutions as the broadcast radius r_{b} increases.

It should be noted that the delays of the message in the D2D-based broadcast exploiting X2 interface substantially exhibits an upper bound substantially independent from the extent of the broadcast area (e.g., the length of the broadcast radius) and form the number of radio base stations comprised in the broadcast area due to the fact that each radio base station starts managing the broadcast within the corresponding cell substantially at the same time. Thus, the upper bound for the delays in the whole broadcast area is determined by (i.e., is substantially equal to) the greater time among the times required to propagate the message within the cells comprised in the broadcast area.

The plot of FIG. 6B shows a 95^{th} percentile of the application-level delay experienced by the user equipment within the broadcast area. The 95^{th} percentile of the application-level delay represents the latency required for reaching almost the 95% of the user equipment within the broadcast area. Particularly, the 95^{th} percentile of the application-level delay experienced by user equipment is expressed as a function of the broadcast radius r_{b} of the broadcast area considered.

A (first) curve 605B, dash-dotted line with triangles, describes the trend of the 95^{th} percentile of the application-level delay as a function of the broadcast radius r_{b} when the broadcast in the test scenario is implemented by instantiating the SRA exploiting the Trickle algorithm.

A (second) curve 610B, dotted line with crosses, describes the trend of the 95^{th} percentile of the application-level delay as a function of the broadcast radius r_{b} when the broadcast in the test scenario is implemented by instantiating the SRA (without exploiting the Trickle algorithm).

A (third) curve 615B, dashed line with dots, describes the trend of the 95^{th} percentile of the application-level delay as a function of the broadcast radius r_{b} when the broadcast in the test scenario is implemented by instantiating the D2D-based broadcast according to an embodiment of the present invention.

Finally, a (fourth) curve 620B, full line with asterisks, describes the trend of the 95th percentile of the application-level delay as a function of the broadcast radius r_{b} when the broadcast in the test scenario is implemented by instantiating the D2D-based broadcast according to an embodiment of the present invention that exploits the X2 interface for forwarding the message among radio base stations.

FIG. 6B highlights that the SRA with Trickle algorithm (curve 605B) obtains again the worst performance, because of the message suppression mechanism enforced by the Trickle algorithm in order to minimize a number of transmissions of the message. Both the considered embodiments of the D2D-based broadcast according to embodiments of the present invention (curves 615B and 620B) show better performance than SRA and SRA with Trickle algorithm (curves 605B and 610B).

For example, the D2D-based broadcast exploiting X2 interface (curve 620B), according to the test scenario parameters mentioned above, guarantees that the broadcast area with a broadcast radius r_{b} of 1200 m (r_{b}=1200 m; i.e., corresponding to the rightmost mark on the abscissa axis in the plot of FIG. 6B) or less is covered in less than 40 ms (corresponding to the second mark on the ordinate axis starting from the origin point in the plot of FIG. 6B). Moreover, for shorter broadcast radius r_{b} ranges (e.g. r_{b}≤200 m; corresponding to the first mark on the abscissa axis starting from the origin point in the plot of FIG. 6B), about only 20-25 ms (the first mark on the ordinate axis starting from the origin point in the plot of FIG. 6B indicating 20 ms),or less, are required to complete the broadcasting.

The plot of FIG. 6C shows an average number of network resources, expressed as resource blocks RB, required to complete the broadcast of a message within the broadcast area. Particularly, the average number of network resources required is expressed as a function of the broadcast radius r_{b} of the broadcast area considered.

A (first) curve 605C, dash-dotted line with triangles, describes the trend of the average number of network resources required as a function of the broadcast radius r_{b} when the broadcast in the test scenario is implemented by instantiating the SRA exploiting the Trickle algorithm.

A (second) curve 610C, dotted line with crosses, describes the trend of the average number of network resources required as a function of the broadcast radius r_{b} when the broadcast in the test scenario is implemented by instantiating the SRA (without exploiting the Trickle algorithm).

A (third) curve 615C, dashed line with dots, describes the average number of network resources required as a function of the broadcast radius r_{b} when the broadcast in the test scenario is implemented by instantiating the D2D-based broadcast according to an embodiment of the present invention.

Finally, a (fourth) curve 620C, full line with asterisks, describes the average number of network resources required as a function of the broadcast radius r_{b} when the broadcast in the test scenario is implemented by instantiating the D2D-based broadcast according to an embodiment of the present invention that exploits the X2 interface for forwarding the message among radio base stations.

FIG. 6C highlights that the SRA (without Trickle algorithm, curve 605A) obtains the worst performance, lacking the message suppression mechanism enforced by the Trickle algorithm that minimize a number of transmissions of the message. Both the considered embodiments of the D2D-based broadcast according to embodiments of the present invention (curves 615C and 620C) show better performance than SRA and SRA with Trickle algorithm (curves 605C and 610C). Particularly, the D2D-based broadcast exploiting X2 interface (curve 620C) again shows the best performance due to the fact that each radio base station manages the broadcast of the message within the respective cell substantially independently from, and substantially at the same time of, the other radio base stations.

1. A method of broadcasting a message among user equipment in a broadcast area covered by a wireless communication network, the wireless communication network comprising at least one radio base station which is adapted to manage communications of user equipment in one or more respective served areas, the method comprising having the at least one radio base station:
identify user equipment comprised in the broadcast area;
among the user equipment within the broadcast area, estimating a set of transmitter user storing the message to be broadcasted;
among the user equipment within the broadcast area, estimating a set of receiver user equipment not storing the message and being able to receive the message sent by at least one transmitter user equipment through a device to device communication, and
selecting a subset of transmitter user equipment for transmitting the message ensuring that the receiver user equipment in said set receive the message with a predetermined confidence.

2. The method according to claim 1, wherein selecting a subset of transmitter user equipment for transmitting the message comprises selecting a minimum number of transmitter user equipment of said set ensuring that the receiver user equipment receive the message with a predetermined confidence.

3. The method according to claim 1, wherein estimating a set of transmitter user equipment comprised in the broadcast area comprises estimating a user equipment within the broadcast area being a transmitter user equipment if a probability (Pᵢ) that said user equipment stores the message (m) equals or exceeds a predetermined threshold (α_{TH}).

4. The method according to claim 1, wherein estimating a set of receiver user equipment comprised in the broadcast area comprises estimating a user equipment within the broadcast area being a receiver user equipment if a probability (Pⱼ) that said user equipment receives the message through a device to device transmission equals or exceeds a further predetermined threshold (α_{TH}).

5. The method according to claim 1, wherein selecting a subset of transmitter user equipment for transmitting the message comprises solving a set cover problem, and wherein the set cover problem is formulated as follows:
$$min {\sum }_{i ∈ TS} {x}_{i} , \\ such that$$
$$1 - {\prod }_{i ∈ TS} ( 1 - {P}_{i} \cdot {P}_{i , j} \cdot {x}_{i} ) \geq {a}_{TH} ∀ j ∈ RS$$
$${x}_{i} ∈ \{ 0 , 1 \} ∀ i ∈ TS$$
where xᵢ is a binary variable that is set to one (1) if a corresponding transmitter user equipment is selected for the subset of transmitter user equipment for transmitting the message, and is set to zero otherwise, Pᵢ is the probability that the transmitter user equipment stores the message, P_{i,j} is a probability that a transmission from the transmitter user equipment is correctly received and decoded by a receiver user equipment, RS is a set comprising the receiver user equipment, TS is a set comprising the transmitter user equipment, and α_{TH} is the predetermined threshold.

6. The method according to claim 1, further comprising allocating network resources for the transmission of the message to selected transmitter user equipment, wherein said allocating network resources comprises allocating a portion of network resources, available for communications from user equipment towards the radio base station 404 to selected transmitter user equipment for performing a device-to-device communication.

7. The method according to claim 6, wherein allocating network resources (RB₀₋₆) further comprises exploiting frequency reuse in order to allocating a same network resource to two or more selected transmitter user equipment; assessing whether a reduction in the probability (Pⱼ) of receiving the message through a device to device transmission occurs for any receiver user equipment due to interference provoked by exploiting frequency reuse for two or more selected transmitter user equipment, and cancelling the frequency reuse whether the probability (Pᵢ) drops below the further predetermined threshold (α_{TH}) for any receiver user equipment.

8. The method according to claim 1, further comprising reiterating:
estimating a set of transmitter user equipment comprised in the broadcast area;
estimating a set of receiver user equipment comprised in the broadcast area;
selecting a subset of transmitter user equipment for transmitting the message, and
assessing anew a probability (Pᵢ) of storing the message for each user equipment comprised in the broadcast area after network resources have been allocated to the selected transmitter user equipment, while for at least one user equipment comprised in the broadcast area the newly assessed probability (Pᵢ) of storing the message is lower than the predetermined threshold (α_{TH}).

9. The method according to claim 1, further comprising allocating network resources to at least one selected transmitter user equipment for transmitting the message to the radio base station; providing the message to at least one further radio base station through an interface arranged for communication between radio base stations, the served area of the further radio base station being at least partially superimposed to the broadcast area, and having the at least one further radio base station providing the message to at least one user equipment located within the broadcast area.

10. A wireless communication network comprising at least one radio base station which is adapted to manage communications of user equipment in one or more respective served areas, the least one radio base station being configured for implementing the method according to claim 1.
